(19) United States
(12) Patent Application Publication
(10) Pub. No.: US 2008/0073361 A1
(43) Pub. Date: Mar. 27, 2008

(54) RESILIENT CONTAINER

(76) Inventor: Roger Brouard, Norwalk, CT (US)

Correspondence Address: MICHAUD-DUFFY GROUP LLP, 306 INDUSTRIAL PARK ROAD, SUITE 206, MIDDLETOWN, CT, 06457, US

(21) Appl. No.: 11/861,006

(22) Filed: Sep. 25, 2007

Related U.S. Application Data
(60) Provisional application No. 60/847,279, filed on Sep. 25, 2006.

(51) Int. Cl. B65D 8/04; B23P 17/04; B65D 8/00

(52) U.S. Cl. 220/669; 220/674; 29/592

(57) ABSTRACT

A container for use in splitting wood including a base for supporting a splitting block thereon. The container includes a resilient rim and a resilient wall extending between the base and the resilient rim. The resilient rim defines an opening and cooperates with the resilient wall to form an interior area for containing wood therein during a splitting operation.

### CROSS-REFERENCE TO RELATED APPLICATION

This application claims priority from provisional application Ser. No. 60/847,279, filed Sep. 25, 2006, the disclosure of which is incorporated by reference herein, in its entirety.

### FIELD OF THE INVENTION

The present invention is generally directed to a resilient container and is more specifically directed to an impact resistant flexible container for use in containing wood pieces generated during a wood splitting operation.

### BACKGROUND OF THE INVENTION

Splitting wood for use as firewood can be done manually with the use of a splitting tool such as an axe or a maul. A piece of wood to be split is positioned on a splitting block and a person swings the splitting tool in a downward striking motion to cause the wood to separate into two or more sections. After the splitting tool strikes the piece of wood, the sections of wood tend to scatter several feet from the splitting block. The scattering causes additional effort because someone will have to walk several feet, bend over and retrieve the sections for stacking, storage, transport or consumption.

### SUMMARY OF THE INVENTION

An embodiment of the present invention includes a container for use in splitting wood. The container includes a base for supporting a splitting block thereon, a resilient rim and a resilient wall extending between the base and the resilient rim. The resilient rim defines an opening and cooperates with the resilient wall to form an interior area for containing wood therein during a splitting operation.

Preferably, at least one of the base, the resilient rim and the resilient wall comprises an impact-resistant resilient material. In one embodiment, the impact-resistant resilient material includes tire rubber (i.e., rubber used for manufacture of tires) and/or recycled tires.

The present invention is also directed to a method for manufacturing a container for use in splitting wood. The method includes providing a base, a plurality of resilient wall panels, a plurality of resilient ribs and a resilient rim. A mold having a male mold-portion and a female mold-portion is also provided. The female mold-portion includes a base receiving surface, a panel and rib receiving surface, and a rim receiving cavity. The base is positioned on the base receiving surface, the resilient ribs and the resilient panels are positioned on the panel and rib receiving surface, and the resilient rim is disposed in the rim receiving cavity. Each of the plurality of resilient panels and each of the plurality of resilient ribs extend between and engage the base and the resilient rim. Each of the plurality of resilient panels is positioned between two of the plurality of resilient ribs.

The male mold-portion is inserted into the female mold-portion and the base, the resilient panels, the resilient ribs and the resilient rim are compressed therebetween. The mold is then heated to a suitable temperature for a suitable time, thereby joining the base to each of the plurality of resilient panels and the plurality of resilient ribs, joining each of the plurality of resilient panels to two of the plurality of resilient ribs; and joining the resilient rim to each of the plurality of resilient panels and the plurality of resilient ribs.

### DESCRIPTION OF THE DRAWINGS

FIG. 1 is a side cross sectional view of the container of the present invention.

FIG. 2 is a top view of the container of FIG. 1 with a plug, splitting block and wood removed.

FIG. 3 is a side cross sectional view of the container having an area of reduced thickness, with the plug, splitting block and wood removed.

FIG. 4 is a side cross sectional view of the container of FIG. 2 in a flexed state, with the plug, splitting block and wood removed.

FIG. 5 is a side view of the container shown with a plurality of wall panels and ribs.

FIG. 6 is a top sectional view of the container of FIG. 5.

FIG. 7 is a partial front cross sectional view of the container of FIG. 1.

FIG. 8 is a top sectional view of the container of FIG. 7.

FIG. 9 is a partial front sectional view of two containers nested in one another.

FIG. 10 is a partial front perspective view of an embodiment of the container having handle passages.

FIG. 11 is front perspective view of a portion of the base.

FIG. 12 is a perspective view of a portion of a mold for manufacturing the container of the present invention.

FIG. 13 is a partial perspective view of a female mold-portion prepared for a molding operation.

FIG. 14 is a side cross sectional view of the mold in a closed state.

### DETAILED DESCRIPTION OF THE PREFERRED EMBODIMENT

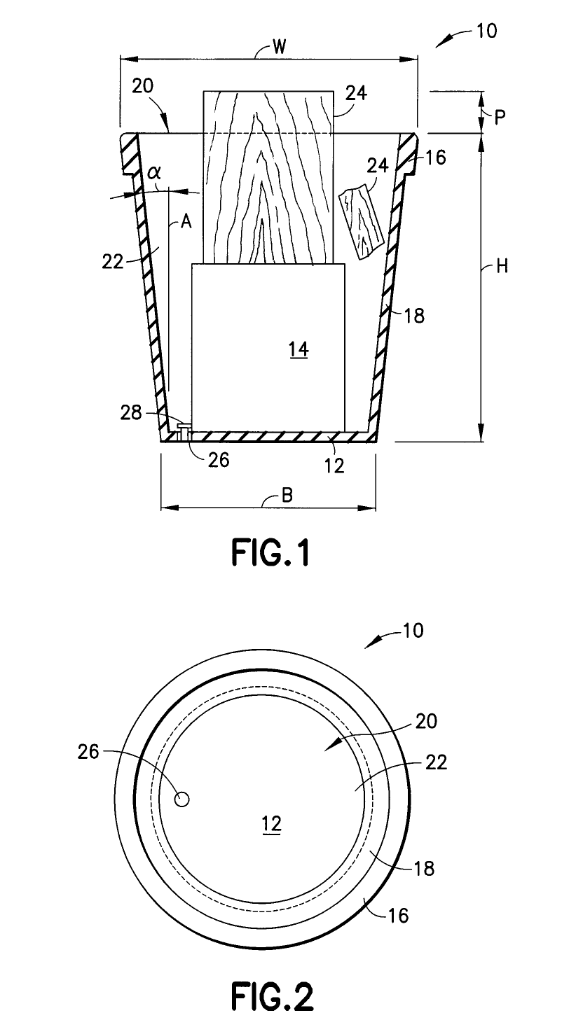

As shown in FIGS. 1 and 2, a container for containing wood therein, generally referred to by the reference number 10, includes a substantially circular base 12 for supporting a splitting block 14 thereon. The container 10 includes a substantially annular shaped resilient rim 16 and a resilient wall 18 extending between the base 12 and the resilient rim. The resilient rim 16 defines an opening 20 and cooperates with the resilient wall 18 to form an interior area 22 for containing wood 24 therein. The base 16 includes a drain port 26 for allowing water or other fluids to drain out of the container 10. A plug 28 is shown installed in the drain port 26, for use in other applications such as for retaining water and ice.

In one embodiment, the container 10 has a height H of about 30 inches, a base B having an outside diameter of about 20 inches and the opening 20 having an outside diameter W of about 24 inches. Prior to splitting, the wood 24 is positioned on the splitting block 14 which is sized to allow the wood to project out of the container 10 by a length P of about 4 inches. After splitting, the wood 24 falls into and is retained in the interior area 22. Because the opening 20 is wider than the base 12, the resilient wall 18 is offset from axis A by angle α of about 5 degrees. However, the present invention is not limited to these dimensions.

In one embodiment, resilient rim 16 and the resilient wall 18 are manufactured from a resilient material resistant to impact and puncture from strikes by a splitting tool, falling wood 24 and other objects. The resilient material elastically yields in response to a force applied thereto and returns to a relaxed state when the force is removed. As such, errant blows by the splitting tool to the resilient rim 16 and the resilient wall 18 result in insignificant permanent deformation to the container 10, thus extending the useful life of it.

A rubber composition used for automotive tires is particularly useful for manufacturing the resilient rim 16 and the resilient wall 18. In another embodiment, shredded recycled tires including fiber reinforced tire sidewalls are used to form the resilient rim 16 and the resilient wall 18. In yet another embodiment, the resilient rim 16 and the resilient wall 18 is manufactured from a fiber reinforced composite material.

The base 12 can also be manufactured from the rubber composition used for automotive tires, shredded recycled tires including fiber reinforced tire sidewalls and fiber reinforced composite material.

While the base 12 is described as being substantially circular and the resilient rim 16 is said to be substantially annular, the present invention is not limited in this regard as other configurations are also included in the scope of the invention, including but not limited to hexagonal, octagonal, square and rectangular shaped configurations.

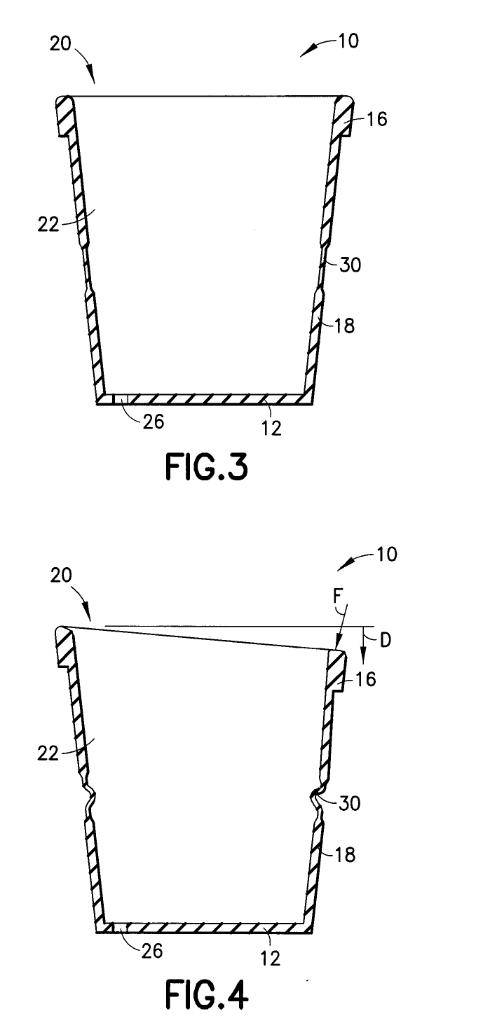

Referring to FIGS. 3 and 4, the resilient wall 18 includes an area of reduced thickness 30 which elastically deforms in the general direction D in response to a force F applied to the resilient rim 16, for example, by the splitting tool. Referring to FIG. 4, the elastic deformation is illustrated as a radially inward deflection of the area of reduced thickness 30. When the force F is removed, the container returns to a relaxed state as shown in FIG. 3.

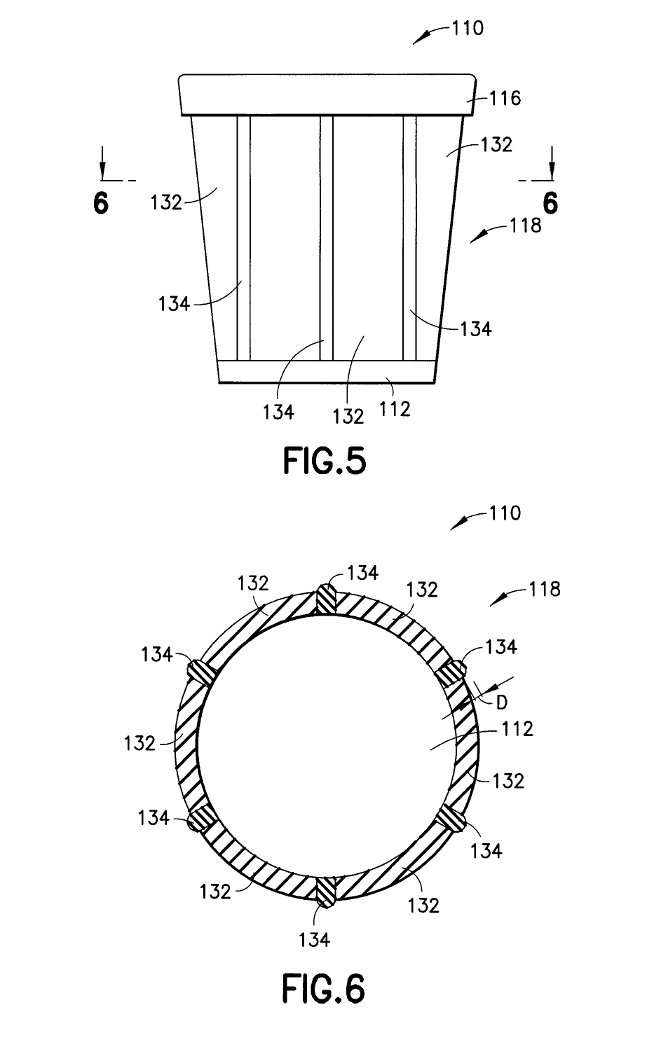

The embodiment shown in FIG. 5 is similar to that of FIG. 1, therefore like elements will be given like numbers preceded by the numeral 1. Referring to FIG. 5, in one embodiment, a container for containing wood therein, generally referred to by the reference number 110, includes a substantially circular base 112 for supporting a splitting block (not shown) thereon. The container 110 includes a substantially annular shaped resilient rim 116 and a resilient wall 118 extending between the base 112 and the resilient rim 116. The resilient wall 118 includes six resilient panels 132 and six resilient ribs 134 each extending between the base 112 and the resilient rim 116. Each of the resilient panels 132 is disposed laterally between two of the resilient ribs 134. The resilient panels 132 are formed as truncated conical segments to facilitate engagement with the base 112 and the resilient rim 116. The resilient ribs 134 are shown to be thicker than the resilient panels such that a portion of each of the resilient ribs 134 projects outwardly from the resilient panels 132. In one embodiment, the resilient ribs 134 project outwardly from the resilient panels 132 by a distance D of about 0.15 to about 0.15 inches.

While the resilient wall 118 is described as having six resilient panels 132 and six resilient ribs 134, the present invention is not limited in this regard as any number of resilient panels and resilient ribs is also contemplated to be within the scope of the present invention. Although the resilient ribs 132 are described as being thicker than the resilient panels 132, the present invention is not limited in this regard as some or all of the resilient panels can be thicker than the resilient ribs, the resilient panels and resilient ribs can be of substantially equal thickness and various combinations thereof.

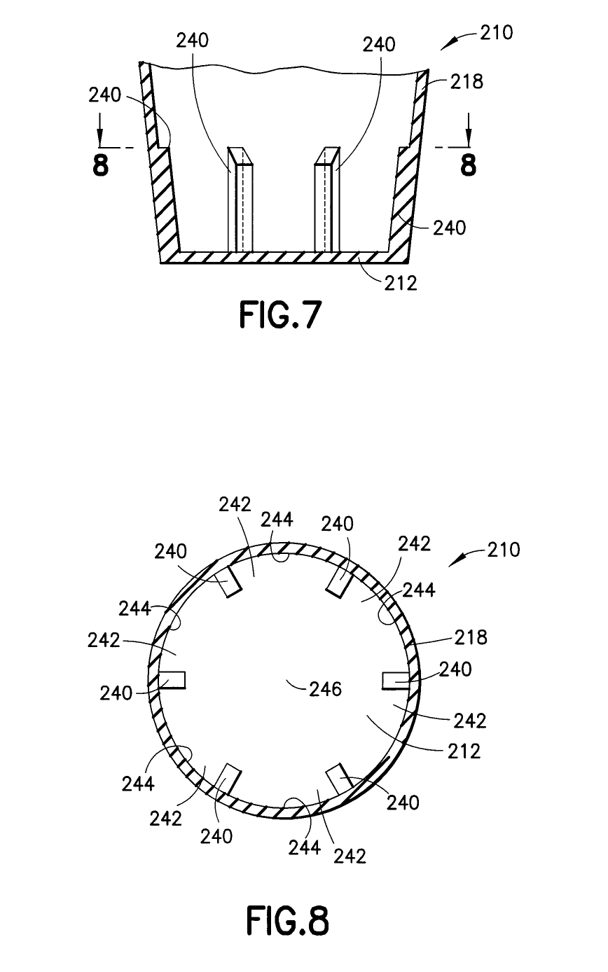

The embodiment shown in FIGS. 7 and 8 is similar to that of FIG. 1, therefore like elements will be given like numbers preceded by the numeral 2. Referring to FIGS. 7 and 8, in one embodiment, a container for containing wood therein, generally referred to by the reference number 210, includes a substantially circular base 212 for supporting a splitting block (not shown) thereon. The container 210 includes a substantially annular shaped resilient rim (not shown) and a resilient wall 218 extending between the base 212 and the resilient rim. The container 210 includes six pedestals 240 projecting from a peripheral portion 242 of the base 212 and projecting inwardly from an inner portion 244 of the resilient wall 218. The pedestals 240 extend partially along the resilient wall 218 and terminate between the resilient rim and base 212. The pedestals 240 also extend radially inward along the base 212 and terminate between the inner portion 244 and a central portion 246 of the base 212.

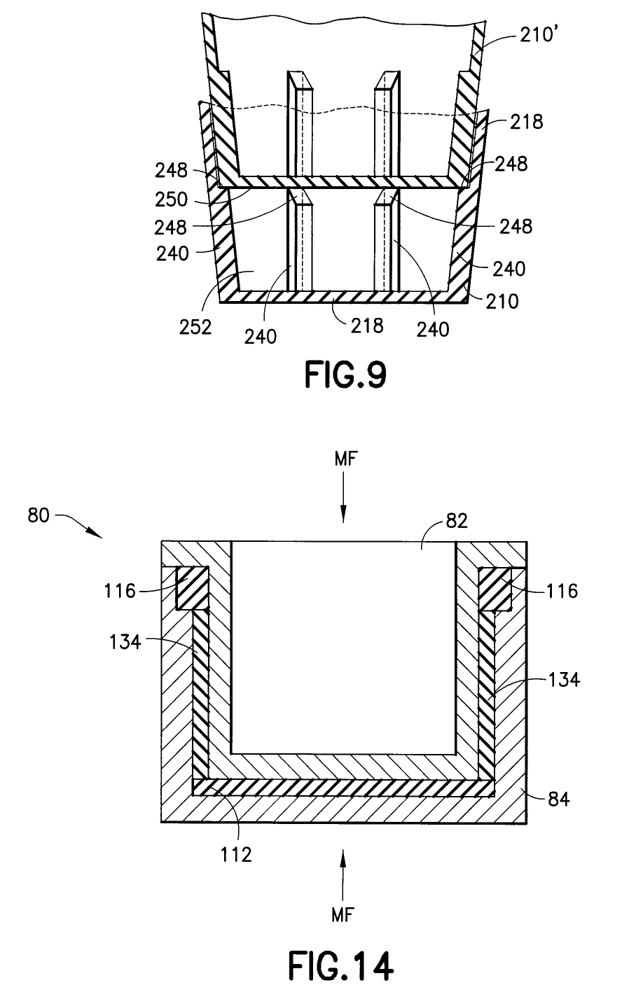

Referring to FIG. 9, the pedestals 240 include support surfaces 248 which engages a mating surface 250 of another container 210′ nested within the container 210. The pedestals 240 provide a standoff area 252 between the mating surface 250 and the base 218, which prevents the container 210′ from becoming stuck in container 210 when container 210′ is nested in container 210.

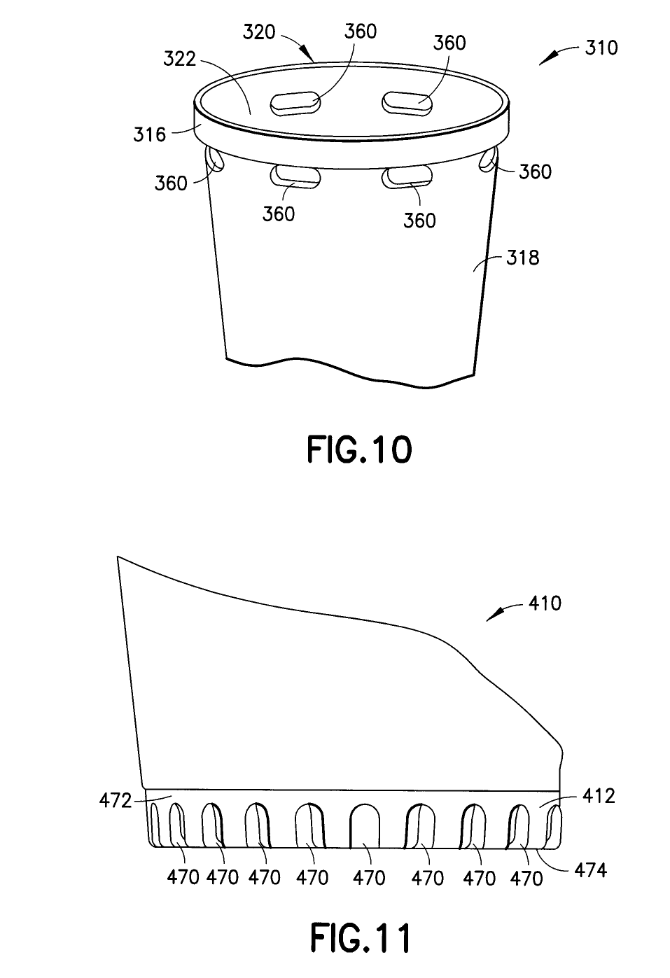

The embodiment shown in FIG. 10 is similar to that of FIG. 1, therefore like elements will be given like numbers preceded by the numeral 3. Referring to FIG. 10, in one embodiment, a container for containing wood therein, generally referred to by the reference number 310, includes a substantially circular base and an annular shaped resilient rim 316 and a resilient wall 318 extending between the base and the resilient rim. The resilient wall 318 includes six handle passages 360 projecting therethrough into the interior area 322. The handle passages 360 are shown circumferentially disposed in the resilient wall 318, substantially equally spaced from one another and adjacent the resilient rim 316. The handle passages 360 are sized to allow a person's hand to fit therein and grip a portion of the resilient rim 316 when lifting the container 310. While six handle passages 360 are described, the present invention is not limited in this regard as the present invention is adaptable to having any number of handle passages at any suitable location.

The embodiment shown in FIG. 11 is similar to that of FIG. 1, therefore like elements will be given like numbers preceded by the numeral 4. Referring to FIG. 11, in one embodiment, a container for containing wood therein, generally referred to by the reference number 410, includes a substantially circular base 412 and an annular shaped resilient rim (not shown) and a resilient wall 418 extending between the base (412) and the resilient rim. The base 412 includes a plurality of groves 470 disposed in an outer circumferential portion 472 of the base and extending to an outside surface 274 of the base. The groves 470 help prevent the container 410 from slipping during a wood splitting operation.

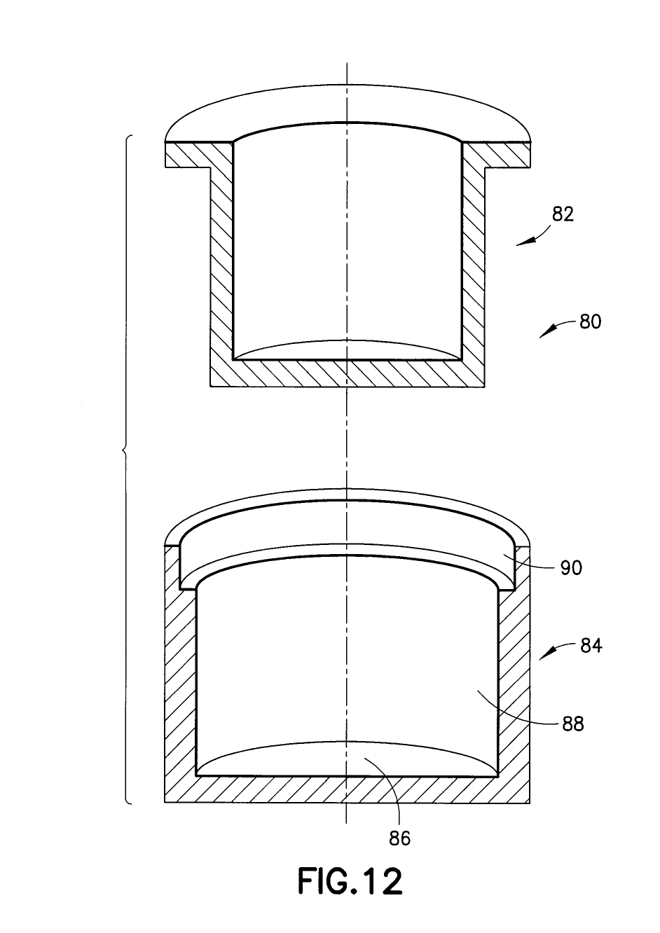

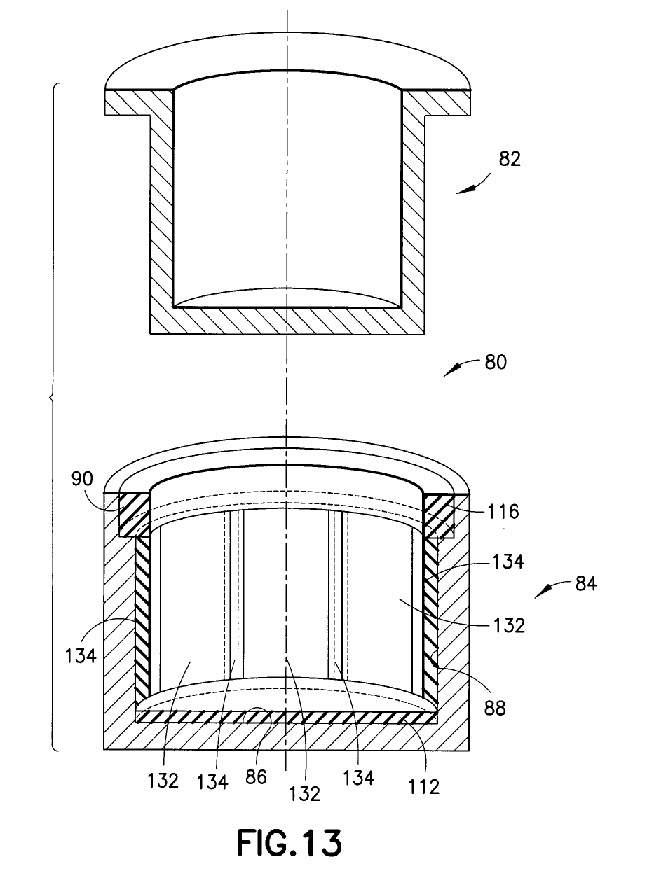

The present invention includes a method for manufacturing a container 110 similar to that illustrated in FIGS. 5 and 6. Referring to FIGS. 12-14, the method includes providing a mold 80 having a male mold-portion 82 and a female mold-portion 84 for compressing the base 112, the resilient panels 132, the resilient ribs 134 and the resilient rim 116 therein. In particular, the female mold-portion 82 includes a base receiving surface 86, a panel and rib receiving surface 88 and a rim receiving cavity 90. Referring to FIG. 13, the method includes positioning the base 112 on the base receiving surface 86, positioning the resilient ribs 134 and the resilient panels 132 on the panel and rib receiving surface 88, positioning the resilient rim 116 in the rim receiving cavity 90, such that the resilient panels and the resilient ribs extend between and engage the base and the resilient rim and such that each resilient panel is positioned between two resilient ribs.

Referring to FIG. 14, the male portion 82 is inserted into the female portion 84 and forces MF are applied to compress the base 112, the resilient panels 132, the resilient ribs 134 and the resilient rim 116 between the male mold-portion 82 and the female mold-portion 84. The mold 80 is heated to a suitable temperature for a suitable time to causing: the base 112 to join to respective portions of the resilient panels 132 and the resilient ribs 134; the resilient ribs to join to the resilient panels; and the resilient rim to join to respective portions of the resilient panels 132 and the resilient ribs 134.

In one embodiment, the method includes the forming the pedestals in the mold.

Although the present invention has been disclosed and described with reference to certain embodiments thereof, it should be noted that other variations and modifications may be made, and it is intended that the following claims cover the variations and modifications within the true scope of the invention.

What is claimed is:

1. A container for use in splitting wood, said container comprising:
a base for supporting a splitting block thereon;
a resilient rim,
a resilient wall extending between said base and said resilient rim; and wherein
said resilient rim defines an opening and cooperates with said resilient wall to form an interior area for containing wood therein during a splitting operation.

2. The container of claim 1, wherein at least one of said base, said resilient rim and said resilient wall comprises an impact-resistant resilient material.

3. The container of claim 1, wherein said base, said resilient rim and said resilient wall comprises an impact-resistant resilient material.

4. The container of claim 1, wherein at least two of said base, said resilient rim and said resilient wall comprises an impact-resistant resilient material.

5. The container of claim 2, wherein said impact-resistant resilient material comprises tire rubber.

6. The container of claim 2, wherein said impact-resistant resilient material comprises recycled tires.

7. The container of claim 2, wherein said impact-resistant resilient material comprises a fiber reinforced composite material.

8. The container of claim 1, wherein a portion of said resilient wall includes an area of reduced thickness, said area of reduced thickness flexing in response to application and removal of a force applied to said container.

9. The container of claim 1, wherein said resilient wall comprises a plurality of resilient panels and a plurality of resilient ribs, each of said plurality of resilient panels being disposed between two of said plurality of resilient ribs, and each of said plurality of resilient ribs having one end coupled to said base and an opposing end coupled to said resilient rim.

10. The container of claim 1, wherein said interior area includes a plurality of pedestals projecting from a peripheral portion of said base and projecting inwardly from said resilient wall, said plurality of pedestals terminating in an axial direction between said resilient rim and said base and between said resilient wall and a central portion of said base.

11. The container of claim 1, wherein at least one of said resilient wall and said base includes at least one drainage port and a removable plug disposed therein.

12. The container of claim 1, wherein said container includes a plurality of passages disposed in at least one of said resilient rim and said resilient wall disposed circumferentially there about for use as handles.

13. The container of claim 1, wherein said base includes a plurality of grooves formed in at least one surface thereof.

14. A method for manufacturing a container for use in splitting wood, the method comprising the steps of:
providing a base, a plurality of resilient wall panels, a plurality of resilient ribs, a resilient rim, a mold having a male mold-portion and a female mold-portion, said female mold-portion including a base receiving surface, a panel and rib receiving surface, and a rim receiving cavity;
positioning said base on said base receiving surface, said resilient ribs and said resilient panels on said panel and rib receiving surface, and said resilient rim in said rim receiving cavity, such that each of said plurality of resilient panels and each of said plurality of resilient ribs extend between and engage said base and said resilient rim and such that each of said plurality of resilient panels is positioned between two of said plurality of resilient ribs;
inserting said male mold-portion into said female mold-portion;
compressing said base, said resilient panels, said resilient ribs and said resilient rim between said male mold-portion and said female mold-portion;
heating said mold to a suitable temperature for a suitable time; and
joining said base to each of said plurality of resilient panels and said plurality of resilient ribs, each of said plurality of resilient panels to two of said plurality of resilient ribs;
and said resilient rim to each of said plurality of resilient panels and said plurality of resilient ribs.
